(19) United States
(12) Patent Application Publication
(10) Pub. No.: US 2026/0362554 A1
(43) Pub. Date: Nov. 12, 2026

(54) CARBON NANOTUBE-INTEGRATED STRETCHABLE PHASE CHANGE ACTUATOR AND METHOD FOR MANUFACTURING THE SAME

(71) Applicant: UIF (UNIVERSITY INDUSTRY FOUNDATION), YONSEI UNIVERSITY, Seoul (KR)

(72) Inventors: Jongbaeg KIM, Seoul (KR); Sangjun SIM, Seoul (KR); Seungin JO, Seoul (KR)

(21) Appl. No.: 19/645,464

(22) Filed: Apr. 13, 2026

(30) Foreign Application Priority Data
May 8, 2025 (KR) 10-2025-0059861

(51) Int. Cl. H05B 3/14; H05B 3/34

(52) U.S. Cl. CPC H05B 3/145; H05B 3/34; H05B 2203/017; H05B 2214/04

(57) ABSTRACT

A stretchable phase change actuator integrated with carbon nanotubes and a method of manufacturing the same are described. The phase change actuator may comprise: a substrate; a heating element formed on the substrate and comprising a material having electrical conductivity and porosity; a first electrode connected to the heating element; a second electrode connected to the heating element and spaced apart from the first electrode; a phase change liquid retained within the heating element; and a stretchable membrane enclosing at least the heating element.

### CROSS-REFERENCE TO RELATED APPLICATION

This application claims priority from Korean Patent Application No. 10-2025-0059861, filed on May 8, 2025, with the Korean Intellectual Property Office (KIPO), and all the benefits accruing therefrom under 35 U.S.C. 119. The contents of each of the above applications are incorporated herein in their entirety by reference.

### BACKGROUND

### Field

The present invention relates to a stretchable phase change actuator integrated with carbon nanotubes and a method of manufacturing the same.

### Description of Related Art

Flexible electronic devices can operate stably even under conditions of mechanical bending or deformation, making them suitable for a wide range of applications in which deformation is unavoidable due to user movement, such as wearable devices and implantable devices. In particular, thin and flexible structures can conform to curved surfaces such as skin, enabling seamless tactile interaction with the user while minimizing discomfort. Tactile interfaces include tactile sensors capable of measuring tactile information such as contact and pressure, and tactile displays capable of delivering tactile information such as static pressure and vibration to the user. Recently, flexible tactile displays have attracted considerable attention as a means of delivering sophisticated tactile stimuli to users in VR/AR applications and human-machine interfaces.

To be utilized as a flexible tactile display, it is necessary to develop an actuator that is mechanically flexible while being capable of providing tactile information perceptible to the user. Accordingly, flexible actuators based on various actuation mechanisms have been reported, including pneumatic, electrostatic, and phase change-based approaches. For example, an ultrathin dielectric elastomer actuator with a thickness of 18 micrometers has been developed. This device can be directly attached to a user's finger to deliver precise vibrotactile stimuli over a frequency range of 1 to 500 Hz, while also sensing tactile information from external objects. Such thin and lightweight actuators may offer a broad range of application possibilities, including non-visual notifications and tactile-based character recognition. However, the maximum actuation displacement is limited to 10 micrometers or less, which may be insufficient for users to perceive static pressure.

More recently, a soft and stretchable haptic actuator based on an electrostatic zipper mechanism has been developed. This actuator can generate sufficient pressure to deliver tactile information to the skin by utilizing a pillar structure for pressure amplification, and can be configured as a high-resolution actuator array suitable for sensitive areas such as fingers, with a pitch of 3 millimeters. In addition, a tactile interface has been demonstrated in which a robot senses information about its external environment and delivers it as tactile feedback to the user's skin. However, such actuators require a pouch structure to contain the dielectric liquid, which presents a limitation in terms of increased device volume.

### SUMMARY

The problem to be solved by the present invention is to utilize the expansive force resulting from vaporization of a phase change material while maintaining stretchability throughout the overall structure of the actuator. In particular, the present invention aims to achieve a miniaturized and simplified structure by integrating the heating element and the chamber structure into a single carbon nanotube bundle. The present invention also focuses on a structural design capable of maintaining stable electrical contact and mechanical sealing even under repeated tensile deformation.

In one aspect, the present invention provides a stretchable phase change actuator comprising: a substrate; a heating element formed on the substrate and comprising a material having electrical conductivity and porosity; a first electrode connected to the heating element; a second electrode connected to the heating element and spaced apart from the first electrode; a phase change liquid retained within the heating element; and a stretchable membrane enclosing at least the heating element.

In one embodiment, the heating element may comprise a carbon nanotube bundle.

In one embodiment, the carbon nanotube bundle may comprise vertically aligned carbon nanotubes (VACNTs) formed perpendicular to the substrate.

In one embodiment, the phase change liquid may comprise water or a liquid containing water.

In one embodiment, the vertically aligned carbon nanotubes may have a hydrophobic peripheral region and a hydrophilic central region, such that the phase change liquid is trapped and retained within the carbon nanotube bundle.

In one embodiment, the stretchable membrane may comprise an elastomer.

In one embodiment, the first electrode or the second electrode may comprise a liquid metal.

In another aspect, the present invention provides a method of manufacturing a stretchable phase change actuator, the method comprising: forming a heating element on a substrate, the heating element comprising a material having electrical conductivity and porosity; connecting a first electrode and a second electrode to the heating element such that the first electrode and the second electrode are spaced apart from each other; impregnating the heating element with a phase change liquid such that the phase change liquid is retained within the heating element; and enclosing at least the heating element with a stretchable membrane.

In one embodiment, the heating element may comprise a carbon nanotube bundle.

In one embodiment, the carbon nanotube bundle may comprise vertically aligned carbon nanotubes (VACNTs) formed perpendicular to the substrate.

In one embodiment, the phase change liquid may comprise water or a liquid containing water.

In one embodiment, the impregnating may comprise applying a hydrophilicity treatment to a central region of the vertically aligned carbon nanotubes, and subsequently impregnating the central region with the phase change liquid.

In one embodiment, the hydrophilicity treatment may be performed by applying oxygen plasma or ozone plasma to the central region of the vertically aligned carbon nanotubes.

In one embodiment, the stretchable membrane may comprise an elastomer.

In one embodiment, the first electrode or the second electrode may comprise a liquid metal.

In yet another aspect, the present invention provides a wearable tactile display comprising: a plurality of actuators arranged to generate displacement toward a skin-facing surface when the wearable tactile display is worn; a power supply configured to supply power to at least a portion of the plurality of actuators; and a controller configured to individually control at least a portion of the plurality of actuators, wherein at least a portion of the plurality of actuators is a stretchable phase change actuator according to an embodiment of the present invention.

In the present invention, a stretchable actuator utilizing a liquid-to-gas phase change has been developed. The actuator comprises a vertically aligned carbon nanotube (VACNT)-based heating element and a liquid metal (EGaIn) electrode, both of which are integrated into a stretchable Ecoflex substrate. Since all components are intrinsically stretchable, the device can be worn in close contact with the skin. The actuator is capable of generating a large actuation displacement of 1 millimeter or more, and demonstrates high durability with little change in actuation performance even after 300 repeated actuation cycles under 100% tensile strain conditions.

The effect of the present invention lies in the fact that the vertically aligned carbon nanotube bundle serves simultaneously as a heating element and as a storage structure for the phase change material, thereby enabling both structural simplification and functional integration. This reduces the overall volume of the actuator and offers the potential to generate self-contained expansion pressure without the need for external devices. In addition, since all components are made of stretchable materials, there is potential for stable operational characteristics to be maintained even under repeated stretching or bending. These properties may help extend the range of applications to various wearable systems, such as skin-adhesive interfaces and garment-integrated devices.

### BRIEF DESCRIPTION OF DRAWINGS

FIG. 1 is a view illustrating a side of a stretchable phase change actuator according to an embodiment of the present invention.

FIG. 2 is a view illustrating a flow of a method of manufacturing a stretchable phase change actuator according to an embodiment of the present invention.

FIG. 3A is a view illustrating a schematic of a proposed stretchable phase change material (PCM) actuator comprising a stretchable elastomer substrate and a VACNT bundle-based heating element, wherein the interior is filled with a liquid phase change material to function as a PCM chamber.

FIG. 3B is a view illustrating an actuation mechanism of a liquid-to-gas phase change-based actuator, wherein upon application of a bias voltage to the CNT bundle, the phase change material is vaporized, a large volumetric expansion occurs during vaporization, and the membrane expands to generate actuation displacement.

FIG. 4A is a view illustrating a first part of a process of transferring vertically aligned carbon nanotube (VACNT) bundles synthesized by a CVD process onto an Ecoflex substrate.

FIG. 4B is a view illustrating a result of transferring vertically aligned carbon nanotube (VACNT) bundles synthesized by a CVD process onto an Ecoflex substrate.

FIG. 4C is a view illustrating a first part of a process of selectively injecting a liquid phase change material (water) into a desired region of the VACNT bundle through a hydrophilic surface treatment process using a shadow mask.

FIG. 4D is a view illustrating a result of selectively injecting a liquid phase change material (water) into a desired region of the VACNT bundle through a hydrophilic surface treatment process using a shadow mask.

FIG. 4E is a view illustrating a first part of a process of forming a sealing layer and a membrane by spin-coating uncured Ecoflex after connecting wiring with a liquid metal.

FIG. 4F is a view illustrating a result of forming a sealing layer and a membrane by spin-coating uncured Ecoflex after connecting wiring with a liquid metal.

FIG. 5A is a view illustrating an optical image of a fabricated stretchable phase change actuator comprising a VACNT-based heating element, a phase change material chamber, and liquid metal electrodes, integrated on a stretchable Ecoflex substrate.

FIG. 5B is a view illustrating an optical image of the actuator before 100% tensile strain is applied (scale bar: 10 mm).

FIG. 5C is a view illustrating an optical image of the actuator after 100% tensile strain is applied, showing that the CNT bundle and the liquid metal electrodes remain connected even after 100% tensile strain (scale bar: 10 mm).

FIG. 6 is a view illustrating an experimental setup in which the stretchable phase change actuator is mounted on a uniaxial stage to apply tensile strain, a bias voltage is applied using a DC power supply, and displacement is measured in real time using a laser displacement sensor.

FIG. 7A is a view illustrating instantaneous displacement curves of the stretchable actuator driven at various power levels.

FIG. 7B is a view illustrating displacement of the stretchable actuator after being driven for 10 seconds at different power levels.

FIG. 8 is a view illustrating instantaneous displacement curves obtained over six cycles of 10-second actuation followed by 140-second cooling at a driving power of 2 W, showing that the actuation displacement is stably maintained during repeated actuation.

FIG. 9 is a view illustrating actuation performance of the stretchable actuator before and after repeated tensile cycling over 100 to 300 cycles.

FIG. 10 is a view illustrating two-dimensional surface height profiles and optical images measured in the powered-on (On) and powered-off (Off) states of the actuator under 0% and 100% tensile strain conditions.

FIG. 11A is a view illustrating the change in output pressure as a function of driving power, showing a trend of progressively increasing output pressure as the power increases from 1 W to 3 W.

FIG. 11B is a view illustrating results of 10 repeated actuation cycles under a driving power of 1 W, showing that a pressure of approximately 2 kPa is stably and repeatedly generated in each cycle.

FIG. 11C is a view illustrating a comparison of results from 3 repeated actuation cycles in the initial state (0% tensile strain) and the stretched state (100% tensile strain) of the actuator, showing that similar pressure responses are observed in both states and that repeated actuation performance is maintained regardless of whether tensile strain is applied.

### DETAILED DESCRIPTIONS

Hereinafter, embodiments of the present invention will be described in detail with reference to the accompanying drawings. Since the present invention may be embodied in many different forms and may be subject to various modifications, certain embodiments are illustrated in the drawings and described in detail herein. However, this is not intended to limit the present invention to any particular disclosed form, and it should be understood that the present invention includes all modifications, equivalents, and substitutes within the spirit and scope of the present invention. Like reference numerals are used for like elements throughout the description of the drawings. In the accompanying drawings, the dimensions of structures are exaggerated relative to actual dimensions for clarity of the present invention.

The terminology used in the present application is used only to describe particular embodiments and is not intended to limit the present invention. The singular forms include the plural forms unless the context clearly dictates otherwise. In the present application, the terms “comprise” or “have” are intended to designate that the features, numbers, steps, operations, elements, or combinations thereof described in the specification exist, and should not be understood to preclude the possibility of the existence or addition of one or more other features, numbers, steps, operations, elements, or combinations thereof. In the context of the present specification, terms such as “about” may mean approximately ±1%, approximately ±2%, approximately ±3%, approximately ±4%, approximately ±5%, approximately ±6%, approximately ±7%, approximately ±8%, approximately ±9%, or approximately ±10% of a numerical value described in the specification.

In addition, the description of one aspect of the present invention may be equally or similarly applied to the same or similar configurations or terms in the description of other aspects.

Unless otherwise defined, all terms used herein, including technical and scientific terms, have the same meanings as those commonly understood by a person of ordinary skill in the art to which the present invention pertains. Terms defined in commonly used dictionaries should be interpreted as having meanings consistent with the meanings in the context of the related art, and unless explicitly defined in the present application, should not be interpreted in an idealized or overly formal sense.

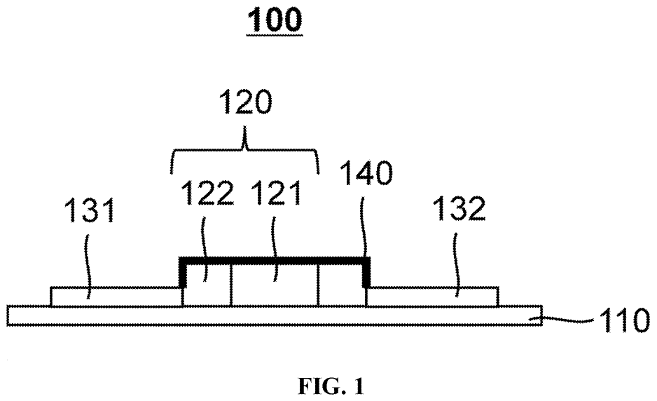

FIG. 1 illustrates a side view of a stretchable phase change actuator 100 according to an embodiment of the present invention.

Referring to FIG. 1, the stretchable phase change actuator 100 according to an embodiment of the present invention may comprise: a substrate 110; a heating element 120 formed on the substrate 110 and comprising a material having electrical conductivity and porosity; a first electrode 131 connected to the heating element 120; a second electrode 132 connected to the heating element 120 and spaced apart from the first electrode 131; a phase change liquid retained within the heating element 120; and a stretchable membrane 140 enclosing at least the heating element 120.

The substrate 110 serves to form a foundational frame that supports the overall actuation structure. In one example, the substrate 110 may be composed of a stretchable or flexible material. When composed of a stretchable or flexible material, the substrate 110 may provide a basis for the entire actuator to respond flexibly to external mechanical deformations such as stretching and bending. Such a flexible substrate 110 may help enhance adaptability in wearable environments or skin-adhesive applications, and may potentially provide a stable structure capable of maintaining positional alignment between components and electrical connections even under repeated mechanical loading.

The heating element 120 serves to generate Joule heat by passing current upon application of an external voltage, while simultaneously retaining the phase change material within its porous structure. By performing this dual function, the heating element 120 may be advantageous for structural simplification and miniaturization, and may secure a stable heat transfer path as a heat source for inducing physical expansion. In addition, the porous structure may be designed to suppress displacement of the phase change material while maintaining rapid thermal responsiveness, thereby contributing to improved precision in repeated actuation.

In one embodiment, the heating element 120 may comprise a carbon nanotube bundle. A carbon nanotube bundle refers to a structure in which a plurality of vertically aligned carbon nanotubes are formed in a densely packed state, and may simultaneously possess high electrical conductivity and thermal conductivity. Such a structure can efficiently generate heat in response to current flow, and the porous nature of the structure may also be advantageous for retaining the phase change material within the interior. In particular, the flexibility and mechanical strength of carbon nanotubes may help suppress structural damage and maintain consistency of heating characteristics even when the actuator undergoes repeated deformation.

In one embodiment, the carbon nanotube bundle may comprise vertically aligned carbon nanotubes (VACNTs) formed perpendicular to the substrate 110. Vertically aligned carbon nanotubes (VACNTs) refer to a nanotube structure that is self-aligned and grown in a direction perpendicular to the surface of the substrate 110, and is characterized by high density and degree of alignment. Such a structure allows current to flow efficiently in the axial direction, and the heat transfer path may also be formed in a short and linear manner, which may be advantageous for localized heating control. In addition, the aligned structure may help stably retain the phase change material within the bundle interior, and tends to maintain its collective form even under external mechanical stimuli such as stretching or compression, thereby contributing to physical stability and functional continuity in repeated actuation environments.

In particular, vertically aligned carbon nanotubes may exhibit insensitivity to tensile strain or deformation. This is because each carbon nanotube within the vertically aligned structure forms a collective mechanical support force through entanglement with or contact between adjacent nanotubes. This structural characteristic may induce individual nanotubes to distributively share loads when external deformations such as stretching or bending are applied, thereby suppressing abrupt collapse of the overall bundle shape or disconnection of electrical pathways. In addition, the high elongation and flexibility of the nanotubes themselves may contribute to increased resistance to deformation, thereby enhancing the likelihood that heating characteristics and structural consistency are maintained even under repeated deformation conditions.

Furthermore, vertically aligned carbon nanotubes are advantageous for rapid heat transfer. This is because individual carbon nanotubes possess high axial thermal conductivity, and this property may be collectively maximized in a vertically aligned arrangement. In particular, carbon nanotubes have a structure capable of efficiently transferring heat through both electrons and lattice vibrations, compared to polycrystalline metals or general polymer materials, and the higher the degree of alignment, the more rapidly heat can travel along a straight-line path without diffusion. Such characteristics may be advantageous for rapidly elevating the local temperature of the heating element 120, and may help rapidly induce vaporization of the phase change material, thereby shortening the actuation response time.

The first electrode 131 and the second electrode 132 serve to form electrical contacts at both ends of the heating element 120 to allow current to be stably applied thereto, thereby inducing Joule heat to be effectively generated within the heating element 120. When both electrodes are composed of stretchable materials, the electrical connection may be maintained even when the entire actuator is subjected to stretching or repeated deformation, thereby potentially mitigating electrical instability or performance degradation during prolonged use. In particular, when liquid metal-based materials are utilized, the change in contact resistance due to structural deformation is small, which may enhance electrical coupling with the heating element 120, and when arranged in a symmetric configuration, may also contribute to suppressing uneven heat distribution during actuation.

The first electrode 131 and the second electrode 132 may also be formed of flexible materials. In one embodiment, the first electrode 131 or the second electrode 132 may comprise a liquid metal. The advantage of liquid metal lies in the fact that it can freely change its shape in response to external mechanical deformation while maintaining electrical conductivity comparable to that of solid metals. This characteristic may be advantageous for maintaining electrode continuity and contact stability even in environments where the entire actuator undergoes repeated deformations such as stretching, compression, and bending. In particular, gallium-based liquid metals with a thin metal oxide layer and excellent fluidity are less susceptible to disconnection of electrical pathways upon deformation, and may also contribute to stably maintaining electrical coupling with carbon nanotubes. In addition, the capability for micropatterning allows flexible adaptation to various electrode designs, offering potential applicability to complex geometries and high-density array structures.

The phase change liquid serves as a medium that induces the volumetric expansion that is central to the driving force. By absorbing heat generated in the heating element 120 and undergoing a phase transition from liquid to gas, the phase change liquid may induce a rapid pressure increase within the enclosed space. This pressure deforms the stretchable membrane 140 to transmit mechanical motion to the exterior, and when the expansion and contraction process is repeated, it may serve to enhance the possibility of continuous actuation as an actuator.

The required properties of the phase change liquid include the ability to vaporize at a relatively low temperature while possessing thermodynamic properties capable of inducing sufficient volumetric expansion upon vaporization. These properties may enable actuation pressure to be generated with low power consumption and may be advantageous for improving response speed. In addition, physical and chemical stability must be maintained through repeated vaporization and condensation cycles, and the possibility of chemical reaction or erosion with the internal structure of the heating element 120 must be low. It is preferable that the viscosity is neither excessively low nor high, so that the liquid can remain within the bundle interior and be appropriately distributed, and that the sealing condition is maintained without leakage even after actuation.

In one embodiment, the phase change liquid may comprise water or a liquid containing water. Non-limiting examples thereof may include ethanol, methanol, isopropanol, butanol, propylene glycol, glycerol, dimethyl sulfoxide (DMSO), acetone, acetonitrile, tetrahydrofuran, ethylene glycol, triethylene glycol, diethylene glycol, formamide, pyridine, triethylamine, 1,4-dioxane, chloroform, dichloromethane, benzene, toluene, xylene, hexane, heptane, octane, diethyl ether, methyltetrahydrofuran, N-methylpyrrolidone (NMP), dimethylformamide (DMF), trichloroethylene, tetrachloroethylene, perfluorohexane, hexafluoroisopropanol, fluorobenzene, bromobenzene, silicone oil, mineral oil, paraffin oil, phenol, cyclohexane, cyclopentane, trifluoroethanol, methyl ethyl ketone, methyl isobutyl ketone, diethyl carbonate, propylene carbonate, and ethylene carbonate.

In one embodiment, the vertically aligned carbon nanotubes may have a hydrophobic peripheral region 122 and a hydrophilic central region 121, such that the phase change liquid is trapped and retained within the carbon nanotube bundle. This allows the phase change liquid to remain within the carbon nanotube bundle interior while being maintained in a state in which it does not easily leak to the exterior, thereby eliminating the need to form a separate fixed chamber or boundary structure. Such a configuration may be advantageous for reducing the overall thickness and complexity of the device, and may offer the advantage of not compromising the functional integrity of the device even in environments requiring flexibility and stretchability. In addition, since spontaneous trapping of the liquid is possible by utilizing the spacing between nanotubes and differences in surface energy, there may also be room to contribute to simplification of the fabrication process and minimization of material usage.

The stretchable membrane 140 serves to transmit the pressure generated by the phase change to the exterior and to act as a physical boundary that protects the internal components. In particular, the stretchable and elastic properties of the membrane enable it to accommodate repeated deformation associated with expansion and contraction, while also performing a sealing function to prevent leakage of the phase change material from the external environment.

In one embodiment, the stretchable membrane 140 may comprise an elastomer. In one example, the stretchable membrane 140 may comprise an Ecoflex elastomer. An elastomer refers to a polymer material that can be easily stretched or deformed by an external mechanical load and that returns to its original shape upon removal of the load. Such physical properties may be usefully employed in devices intended to maintain structural stability even under repeated actuation or external impact. In particular, elastomers with low Young's modulus and high elongation are suitable for flexible and skin-friendly devices, and may respond sensitively even to minute pressure changes or expansion, thereby helping to improve the dynamic response characteristics of the actuator. In addition, since processing into various hardness levels and thicknesses is possible, the specific amount of deformation can be adjusted according to the intended application, which may serve as an additional advantage.

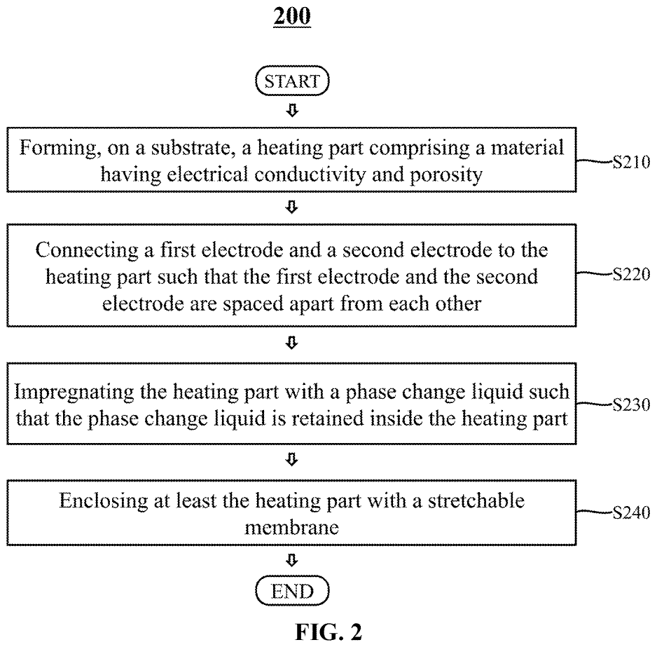

FIG. 2 illustrates a flowchart of a method 200 of manufacturing a stretchable phase change actuator according to an embodiment of the present invention.

Referring to FIG. 2, the method 200 of manufacturing a stretchable phase change actuator according to an embodiment of the present invention may comprise: a heating element forming step S210 of forming a heating element on a substrate, the heating element comprising a material having electrical conductivity and porosity; an electrode connecting step S220 of connecting a first electrode and a second electrode to the heating element such that the first electrode and the second electrode are spaced apart from each other; a liquid impregnation step S230 of impregnating the heating element with a phase change liquid such that the phase change liquid is retained within the heating element; and a membrane enclosing step S240 of enclosing at least the heating element with a stretchable membrane.

The heating element forming step S210 serves not only to form a structure capable of generating heat, but also to form a structural foundation capable of retaining the phase change liquid. In particular, when a material simultaneously possessing electrical conductivity and porosity is utilized, heat can be rapidly generated upon application of current, and the generated heat can be efficiently transferred into the liquid interior to contribute to inducing a vaporization reaction. The porous structure may help prevent the liquid from easily leaking to the exterior while maintaining a stably distributed state within the interior, thereby providing a basis for maintaining consistent operation even in repeated actuation environments.

In one embodiment, the heating element may comprise a carbon nanotube bundle. In one embodiment, the carbon nanotube bundle may comprise vertically aligned carbon nanotubes (VACNTs) formed perpendicular to the substrate.

The electrode connecting step S220 serves to form electrical contacts for allowing current to flow stably through the heating element. When the first electrode and the second electrode are appropriately spaced apart and connected at both ends of the heating element, current can pass through the entire heating element to induce a uniform heat distribution. When flexible electrode materials are used in this step, contact stability may be enhanced without compromising the overall stretchability of the actuator.

The liquid impregnation step S230 serves to appropriately impregnate the heating element with the phase change liquid, thereby establishing a physical basis for the vaporization reaction necessary for subsequent actuation. In particular, selectively injecting or infiltrating the liquid into the central region of the heating element may be advantageous for stably fixing the position of the liquid while reducing structural complexity. Since the impregnated liquid is retained within a confined space inside the bundle, it may contribute to reducing energy loss during actuation and effectively inducing mechanical expansion.

In one embodiment, the phase change liquid may comprise water or a liquid containing water.

The membrane enclosing step S240 serves to protect the heating element and the phase change liquid retained therein from the external environment, and to form an outer shell structure that physically supports the gas expansion generated during actuation. The stretchable membrane used in this step can accommodate repeated expansion and contraction, which may be advantageous for securing long-term durability. In addition, the membrane may prevent penetration of external contaminants or moisture while functioning as part of the actuation mechanism that effectively transmits internal pressure to the exterior. By simultaneously performing sealing and elastic functions structurally, there may be room to contribute to securing the stability of the overall system and consistent actuation behavior.

In one embodiment, the liquid impregnation step S230 may be performed by applying a hydrophilicity treatment to a central region of the vertically aligned carbon nanotubes, and subsequently impregnating the central region with the phase change liquid. In the present specification, the hydrophilicity treatment refers to a process of modifying the chemical properties of the inherently hydrophobic carbon nanotube surface to impart hydrophilicity to the surface so that polar liquids such as water can easily spread and remain on the surface.

Such treatment may generally be performed by oxygen plasma, UV/ozone treatment, or chemical oxidation methods using an oxidizing agent, and the treated region is transformed into an energy state in which liquid can spontaneously penetrate or adsorb. When hydrophilicity is selectively imparted only to specific regions within the vertically aligned structure, the phase change liquid can be induced to be stably trapped only at specific positions, which may help improve controllability of liquid distribution and positional precision.

In one embodiment, the hydrophilicity treatment may be performed by applying oxygen plasma or ozone plasma to the central region of the vertically aligned carbon nanotubes. This may induce the phase change liquid to selectively remain in the central region of the vertically aligned carbon nanotubes, and by distinguishing it from the hydrophobic peripheral region, unnecessary diffusion or leakage of the liquid may be suppressed. Such selective surface modification enables spontaneous positional alignment of the liquid, which may help improve impregnation efficiency without a separate liquid injection structure or mechanical boundary. In addition, by concentrating the phase change liquid at the center of the heat transfer path, there may also be potential to secure spatial consistency of the vaporization reaction during heating and to contribute to improving reproducibility and stability of the actuation response.

In one embodiment, the stretchable membrane may comprise an elastomer. In one embodiment, the first electrode or the second electrode may comprise a liquid metal.

Meanwhile, the wearable tactile display according to an embodiment of the present invention may comprise: a plurality of actuators arranged to generate displacement toward a skin-facing surface when the wearable tactile display is worn; a power supply configured to supply power to at least a portion of the plurality of actuators; and a controller configured to individually control at least a portion of the plurality of actuators, wherein at least a portion of the plurality of actuators may be a stretchable phase change actuator according to an embodiment of the present invention.

The stretchable phase change actuator proposed in the present invention has the following distinctive advantages compared to existing research and inventions. First, by integrating vertically aligned carbon nanotubes synthesized at high temperatures onto a polymer substrate through a low-temperature transfer process, the possibility of application to various flexible substrates without thermal damage is secured. Second, since the carbon nanotube bundle functions simultaneously as a heating element and as a chamber for trapping the phase change material, a stretchable device capable of achieving structural simplification and miniaturization is realized. Third, the configuration integrating a polymer substrate and carbon-based nanomaterials enables device design with high stretchability and mechanical flexibility, and may operate as a structure capable of maintaining functionality under various deformation conditions.

Hereinafter, embodiments of the present invention are described. However, the embodiments described below are merely some embodiments of the present invention, and the scope of the present invention is not limited to the following embodiments.

### Design and Fabrication

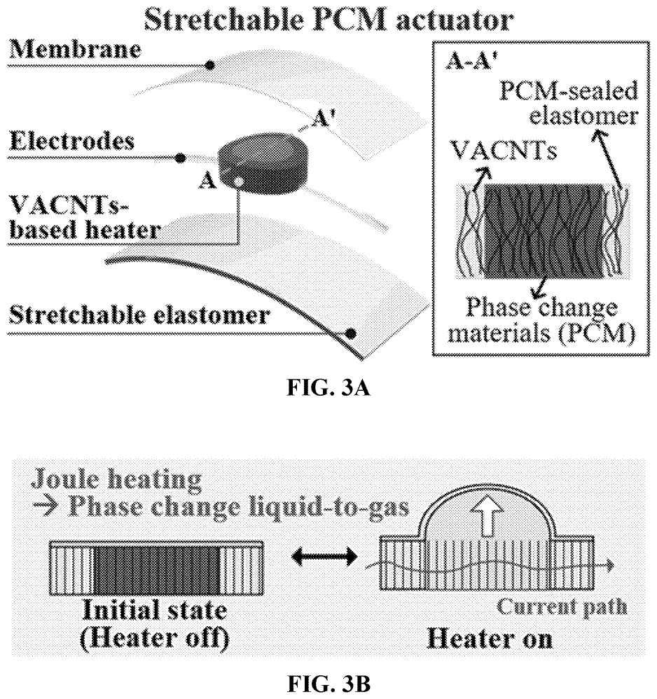

FIGS. 3A and 3B illustrate a schematic and actuation mechanism of a stretchable phase change material (PCM) actuator. Referring to FIG. 3A, a VACNT-based heating element comprising PCM is integrated on a stretchable substrate. The liquid PCM is filled within the VACNT bundle interior, and the edges of the bundle are surrounded by elastomer walls. Referring to FIG. 3B, the actuation mechanism of the PCM actuator is shown. In the initial state, no voltage is applied and the surface of the actuator remains flat. Upon application of voltage, current flows along the axially entangled VACNT strands, generating Joule heating. Heat is transferred from the CNTs to the PCM (water), causing vaporization. As a result, the PCM chamber expands and deforms the membrane upward.

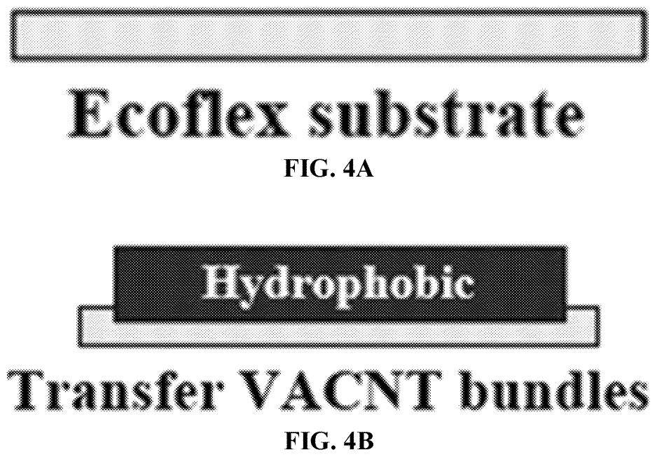

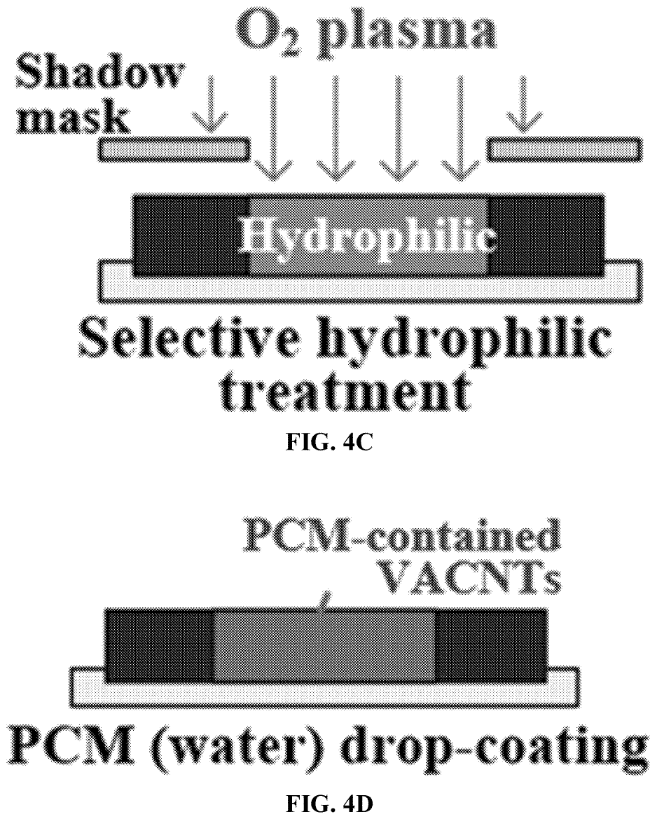

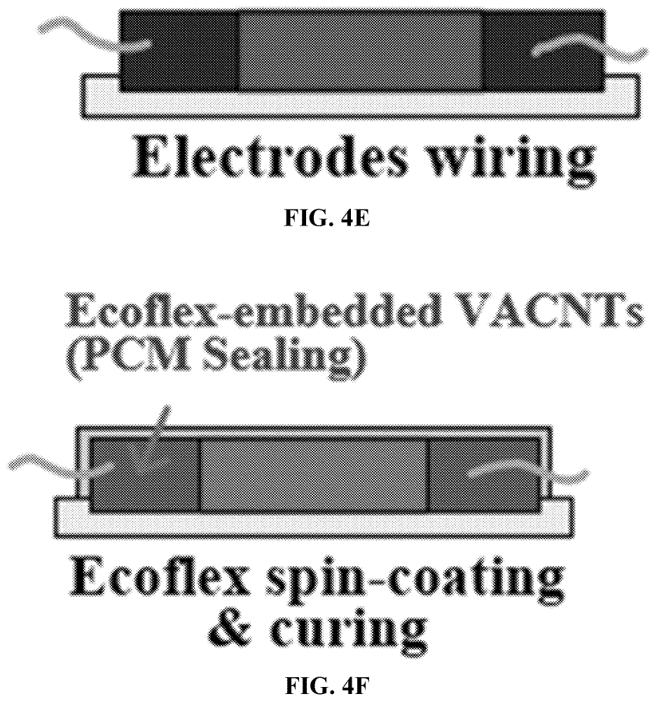

FIGS. 4A through 4F illustrate the fabrication process of the stretchable PCM actuator. The VACNT bundle is transferred onto a stretchable Ecoflex substrate. First, uncured Ecoflex is spin-coated onto the substrate. The donor substrate on which the VACNTs are formed is placed on top of the Ecoflex layer so that the CNT strands are partially embedded in the Ecoflex, which is then cured. Upon removal of the donor substrate, a portion of the CNT strands remains adhered to the Ecoflex and exposed at the surface (FIG. 4B). The hydrophobic VACNT bundle is selectively converted to a hydrophilic region through oxygen plasma treatment (FIG. 4C). When a water droplet is applied in this state, the water is fixed only in the plasma-treated region, i.e., the hydrophilic region (FIG. 4D). After connecting the liquid metal electrodes, uncured Ecoflex is again spin-coated and cured. In this step, the uncured Ecoflex penetrates only into the VACNT regions without water, and an Ecoflex membrane is formed in the water-filled regions.

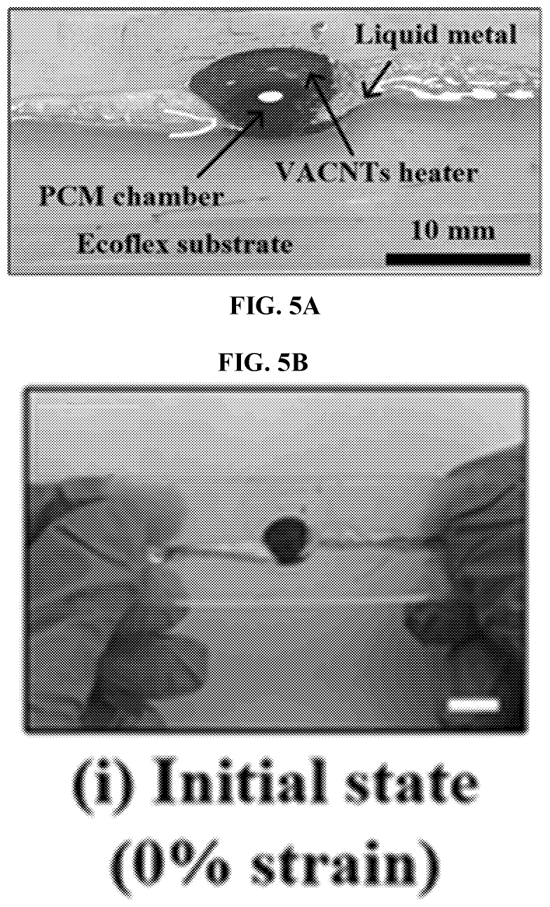

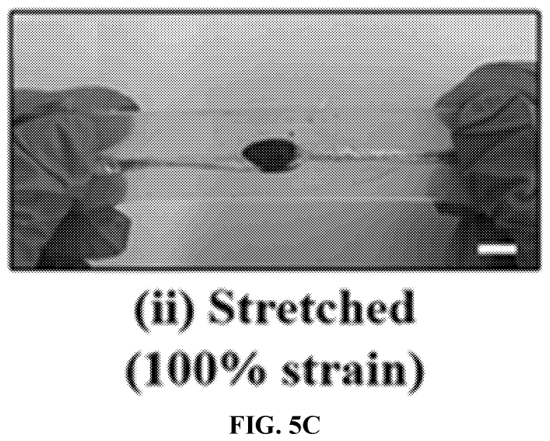

FIGS. 5A through 5C illustrate optical images of the stretchable PCM actuator. Referring to FIG. 5A, an optical image of the entire fabricated stretchable PCM actuator device can be confirmed. In the image, the circular black region at the center is the VACNT-based heating element (VACNTs heater), and the bright spot within it corresponds to the PCM chamber. Liquid metal electrodes are connected on both sides of the heating element, and the entire structure is integrated on a stretchable Ecoflex substrate (scale bar: 10 mm). As shown in FIGS. 5B and 5C, even under 100% tensile strain, the connection between the liquid metal and the CNT heating element is stably maintained without disconnection. Since all components including the heating element and electrodes are composed of elastic materials, the phase change material can be effectively heated even under mechanical deformation.

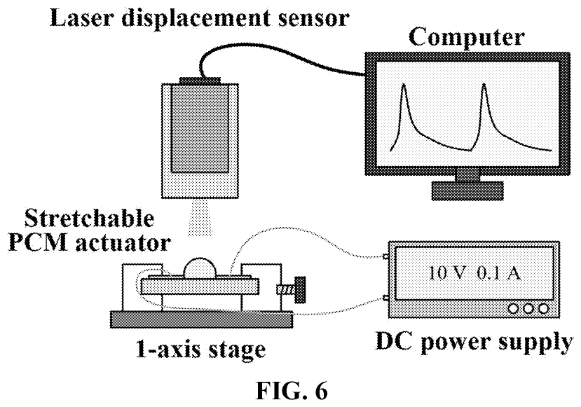

FIG. 6 illustrates a schematic of the experimental setup for measuring the actuation displacement of the device. The PCM actuator was mounted on a uniaxial tensile stage, and actuation displacement was measured in real time through a laser displacement sensor while a bias voltage was applied.

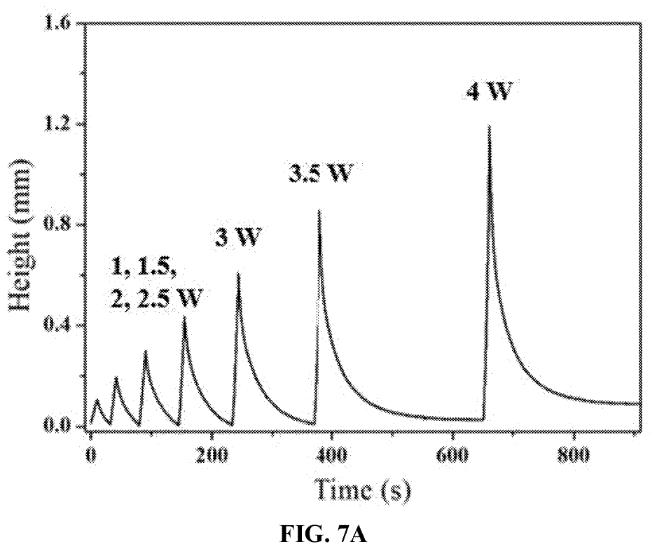

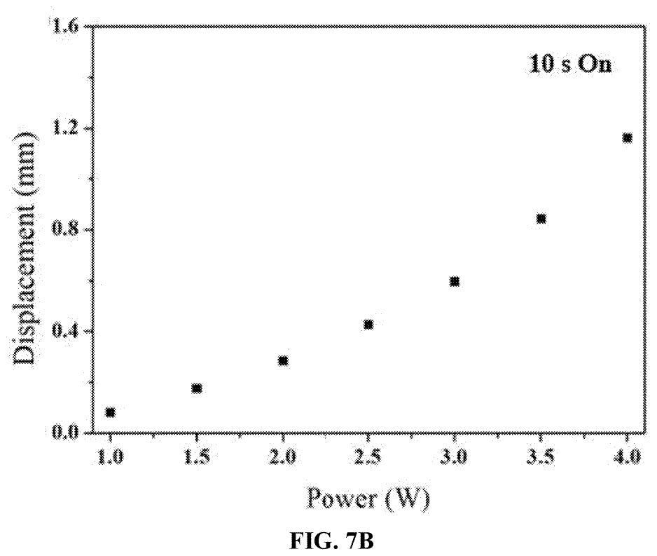

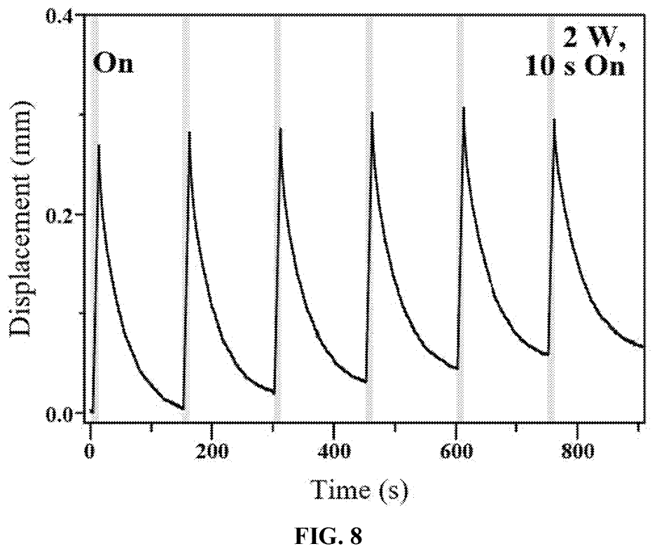

FIGS. 7A and 7B show the actuation displacement measured when various driving powers of 1 to 4 W were applied for 10 seconds. It can be confirmed that greater displacement occurs as the power increases within the same actuation duration.

FIG. 8 shows transient curves over 6 cycles, with each cycle consisting of 10 seconds of actuation at 2 W followed by a 140-second rest period. It can be confirmed that an actuation displacement of approximately 300 micrometers is repeatedly achieved.

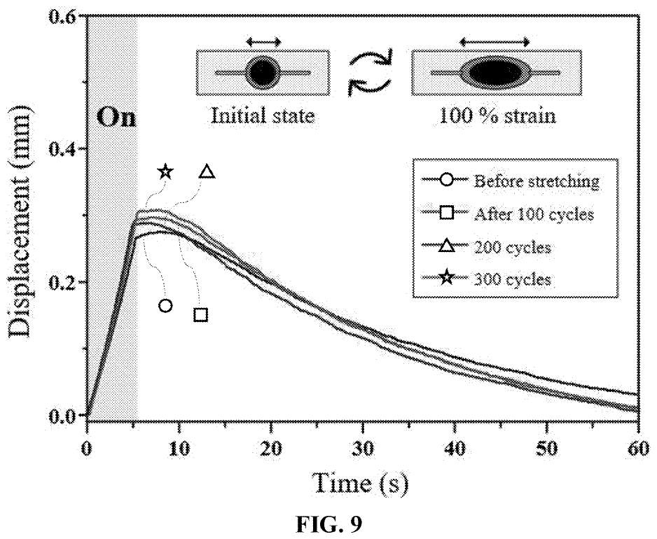

FIG. 9 shows the performance evaluation in which 100% tensile strain was repeatedly applied to the device 300 times. The results demonstrate that the device maintains stable operation despite repeated mechanical deformation.

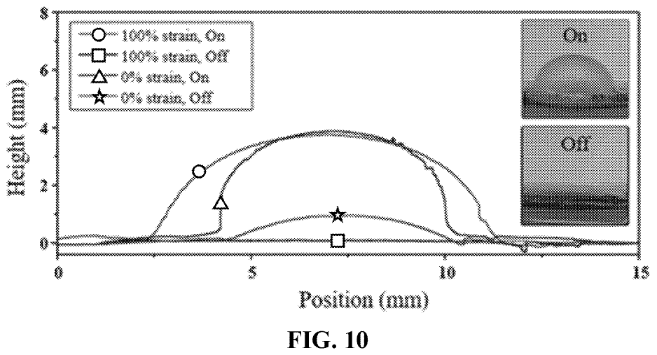

FIG. 10 illustrates two-dimensional surface height profiles and optical images measured in the powered-on (On) and powered-off (Off) states of the actuator under 0% and 100% tensile strain conditions. Referring to FIG. 10, in the powered-off state, there is little change in surface height regardless of whether tensile strain is applied, whereas in the powered-on state, an actuation displacement of approximately 3 mm is observed in the non-stretched state (0% strain, On) and an actuation displacement of approximately 6 mm or more is observed in the stretched state (100% strain, On). The optical images inserted on the right also visually confirm that dome-shaped expansion is clearly observed when power is applied (On), while a flat state is maintained when power is not applied (Off). FIG. 10 confirms that the stretchable phase change actuator of the present invention can induce large displacement through electrical actuation and can maintain stable actuation performance even under 100% tensile strain conditions. This suggests the potential of the actuator to secure high responsiveness and reproducibility even in repeated stretching environments.

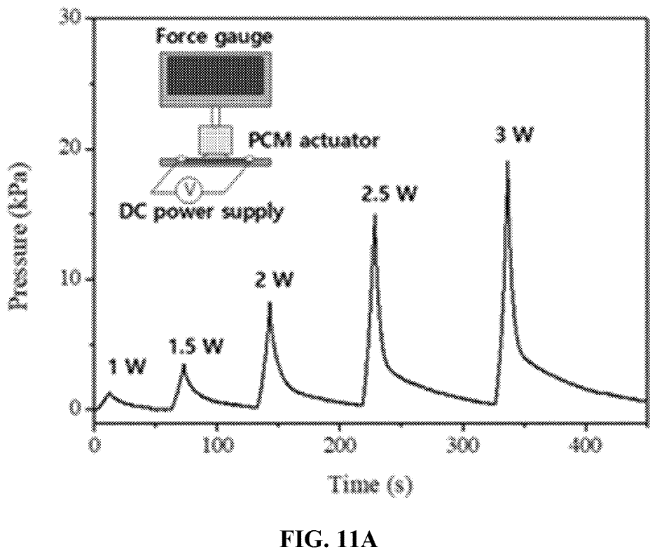

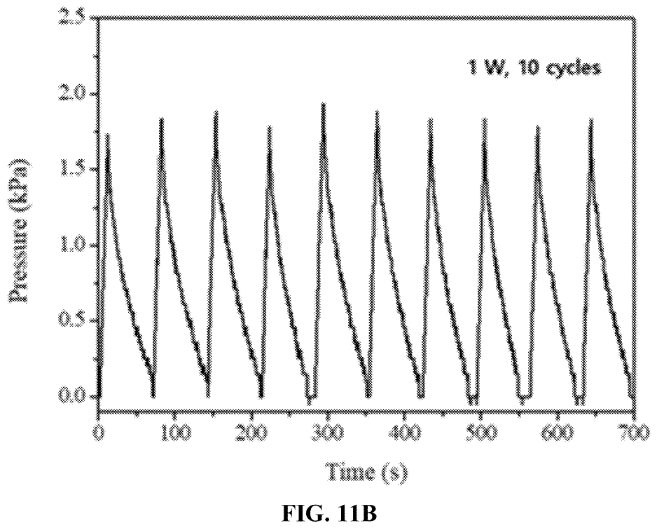

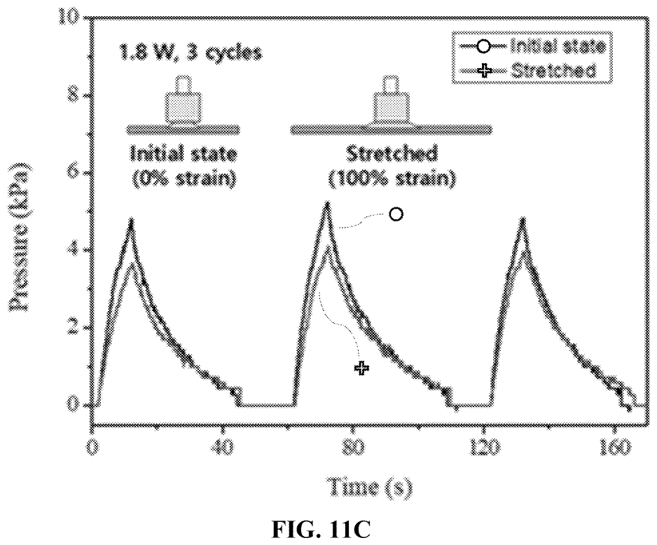

FIGS. 11A through 11C illustrate the actuation pressure measurement results of the stretchable phase change actuator. Referring to FIG. 11A, the change in pressure generated as a function of driving power is shown, confirming a trend of progressively increasing output pressure as the power increases from 1 W to 3 W. Referring to FIG. 11B, the results of 10 repeated actuation cycles under a driving power of 1 W show that a pressure of approximately 2 kPa is stably and repeatedly generated in each cycle. Referring to FIG. 11C, a comparison of results from 3 repeated actuation cycles in the initial state (0% tensile strain) and the stretched state (100% tensile strain) of the actuator shows that similar pressure responses are observed in both states, suggesting that repeated actuation performance is maintained regardless of whether tensile strain is applied. FIGS. 11A through 11C confirm that the stretchable phase change actuator of the present invention can precisely regulate actuation pressure according to input power, exhibits high reproducibility of output during repeated actuation, and can maintain stable pressure output without functional degradation even under tensile strain conditions. This demonstrates that the structure is capable of providing reliable actuation performance across various operating environments.

### Conclusion

In the present invention, a PCM actuator with high stretchability and robustness was realized by integrating a VACNT-based heating element and liquid metal electrodes onto a soft elastomer substrate. Unlike conventional actuators with limited displacement or stretchability, the present device enables large millimeter-scale deformation through a liquid-to-gas phase change mechanism, while simultaneously maintaining stable operation even under large mechanical deformation conditions. The utilization of entangled carbon nanotubes effectively suppresses resistance changes, helping to maintain consistent heating performance even under repeated actuation or high tensile strain conditions. Experimental results confirmed that the actuator responds reliably across various power input conditions and that functionality is sustained even after extensive mechanical stretching. These results demonstrate the potential of PCM-based actuation technology to contribute to the realization of next-generation skin-attachable tactile interfaces.

Although the present invention has been described with reference to preferred embodiments thereof, those skilled in the art will understand that various modifications and changes may be made to the present invention without departing from the spirit and scope of the present invention as set forth in the claims below.

### REFERENCE NUMERALS

100: phase change actuator
110: substrate
120: heating element
121: central region
122: peripheral region
131: first electrode
132: second electrode
140: stretchable membrane
200: method of manufacturing a stretchable phase change actuator
S210: heating element forming step
S220: electrode connecting step
S230: liquid impregnation step
S240: membrane enclosing step

What is claimed is:

1. A stretchable phase change actuator comprising: a substrate; a heating element formed on the substrate and comprising a material having electrical conductivity and porosity; a first electrode connected to the heating element; a second electrode connected to the heating element and spaced apart from the first electrode; a phase change liquid retained within the heating element; and a stretchable membrane enclosing at least the heating element.

2. The stretchable phase change actuator of claim 1, wherein the heating element comprises a carbon nanotube bundle.

3. The stretchable phase change actuator of claim 2, wherein the carbon nanotube bundle comprises vertically aligned carbon nanotubes (VACNTs) formed perpendicular to the substrate.

4. The stretchable phase change actuator of claim 3, wherein the phase change liquid comprises water or a liquid containing water.

5. The stretchable phase change actuator of claim 4, wherein the vertically aligned carbon nanotubes have a hydrophobic peripheral region and a hydrophilic central region, such that the phase change liquid is trapped and retained within the carbon nanotube bundle.

6. The stretchable phase change actuator of claim 1, wherein the stretchable membrane comprises an elastomer.

7. The stretchable phase change actuator of claim 1, wherein the first electrode or the second electrode comprises a liquid metal.

8. A method of manufacturing a stretchable phase change actuator, the method comprising: forming a heating element on a substrate, the heating element comprising a material having electrical conductivity and porosity; connecting a first electrode and a second electrode to the heating element such that the first electrode and the second electrode are spaced apart from each other; impregnating the heating element with a phase change liquid such that the phase change liquid is retained within the heating element; and enclosing at least the heating element with a stretchable membrane.

9. The method of claim 8, wherein the heating element comprises a carbon nanotube bundle.

10. The method of claim 9, wherein the carbon nanotube bundle comprises vertically aligned carbon nanotubes (VACNTs) formed perpendicular to the substrate.

11. The method of claim 10, wherein the phase change liquid comprises water or a liquid containing water.

12. The method of claim 11, wherein the impregnating comprises applying a hydrophilicity treatment to a central region of the vertically aligned carbon nanotubes, and subsequently impregnating the central region with the phase change liquid.

13. The method of claim 12, wherein the hydrophilicity treatment comprises applying oxygen plasma or ozone plasma to the central region of the vertically aligned carbon nanotubes.

14. The method of claim 8, wherein the stretchable membrane comprises an elastomer.

15. The method of claim 8, wherein the first electrode or the second electrode comprises a liquid metal.

16. A wearable tactile display comprising: a plurality of actuators arranged to generate displacement toward a skin-facing surface when the wearable tactile display is worn; a power supply configured to supply power to at least a portion of the plurality of actuators; and a controller configured to individually control at least a portion of the plurality of actuators, wherein at least a portion of the plurality of actuators is the stretchable phase change actuator of claim 1.
